(19) United States
(12) Patent Application Publication
(10) Pub. No.: US 2025/0229764 A1
(43) Pub. Date: Jul. 17, 2025

(54) HYBRID ELECTRIC VEHICLE

(71) Applicant: Toyota Jidosha Kabushiki Kaisha, Toyota-shi (JP)

(72) Inventor: Tohru NISHIURA, Toyota-shi (CN)

(73) Assignee: Toyota Jidosha Kabushiki Kaisha, Toyota-shi (JP)

(21) Appl. No.: 19/019,604

(22) Filed: Jan. 14, 2025

(30) Foreign Application Priority Data
Jan. 16, 2024 (JP) 2024-004656

(51) Int. Cl. B60W 20/10; B60W 10/08; B60W 10/26

(52) U.S. Cl. CPC B60W 20/10; B60W 10/08; B60W 10/26; B60W 2510/0657; B60W 2710/083; B60W 2710/244

(57) ABSTRACT

A hybrid vehicle of the present disclosure includes an engine connectable to a drive shaft, an electric motor connectable to the drive shaft, a battery that exchanges electric power with the electric motor, and a controller that sets an upper limit torque and a lower limit torque of the electric motor such that a difference between a torque command indicating a torque to be output to the drive shaft and an actual torque output to the drive shaft is within an allowable range based on an operational condition of the hybrid vehicle, and controls the electric motor to output a torque based on a difference between the torque command and an estimated output torque of the engine within a range from the lower limit torque to the upper limit torque.

### CROSS-REFERENCE TO RELATED APPLICATION

The present disclosure claims priority to Japanese Patent Application No. 2024-004656 filed on Jan. 16, 2024, which is incorporated herein by reference in its entirety including specification, drawings and claims.

### TECHNICAL FIELD

The present disclosure relates to a hybrid vehicle that includes an engine and an electric motor respectively connectable to a drive shaft.

### BACKGROUND

A conventionally known hybrid vehicle includes an engine connected to a drive shaft, an electric motor connected to the drive shaft, and a controller that controls the engine and the electric motor based on a required drive torque to be output to the drive shaft (see, for example, Japanese Patent Application Laid Open No. 2022-164093). In the hybrid vehicle, the controller calculates an estimated output torque of the engine based on an accelerator pedal position, a vehicle speed, an atmospheric pressure, an outside temperature, and the like, and controls the electric motor to output a torque based on a difference between the required drive torque and the estimated output torque of the engine.

### SUMMARY

However, when the estimated output torque deviates from the actual output torque of the engine in the above conventional hybrid vehicle, the actual output torque of the electric motor may deviate from an actually required motor torque, such that an acceleration state and a deceleration state of the hybrid vehicle may become unintended by the driver.

A main object of the present disclosure is to suppress a deviation of an actual output torque of the electric motor from an actually required motor torque when the estimated output torque of the engine deviates from the actual output torque of the engine.

A hybrid vehicle of the present disclosure includes an engine connectable to a drive shaft, an electric motor connectable to the drive shaft, a battery that exchanges electric power with the electric motor, and a controller. The controller sets an upper limit torque and a lower limit torque of the electric motor such that a difference between a torque command indicating a torque to be output to the drive shaft and an actual torque output to the drive shaft is within an allowable range based on an operational condition of the hybrid vehicle. Further, the controller controls the electric motor to output a torque based on a difference between the torque command and an estimated output torque of the engine within a range from the lower limit torque to the upper limit torque. This enables a deviation of an actual output torque of the electric motor from an actually required motor torque to be suppressed when the estimated output torque of the engine deviates from an actual output torque of the engine.

### BRIEF DESCRIPTION OF DRAWINGS

FIG. 1 is a schematic configuration diagram illustrating the hybrid vehicle of the present disclosure;

FIG. 2 is a flowchart illustrating one example of a routine executed by the controller of the hybrid vehicle of the present disclosure;

FIG. 3 is an explanatory view illustrating a control procedure for the electric motor in the hybrid vehicle of the present disclosure;

FIG. 4 is an explanatory view illustrating a control procedure for the electric motor in the hybrid vehicle of the present disclosure;

FIG. 5 is an explanatory view illustrating a control procedure for the electric motor in the hybrid vehicle of the present disclosure; and

FIG. 6 is a schematic configuration diagram illustrating another hybrid vehicle of the present disclosure.

### DESCRIPTION OF EMBODIMENTS

The following describes some aspects of the present disclosure with reference to drawings.

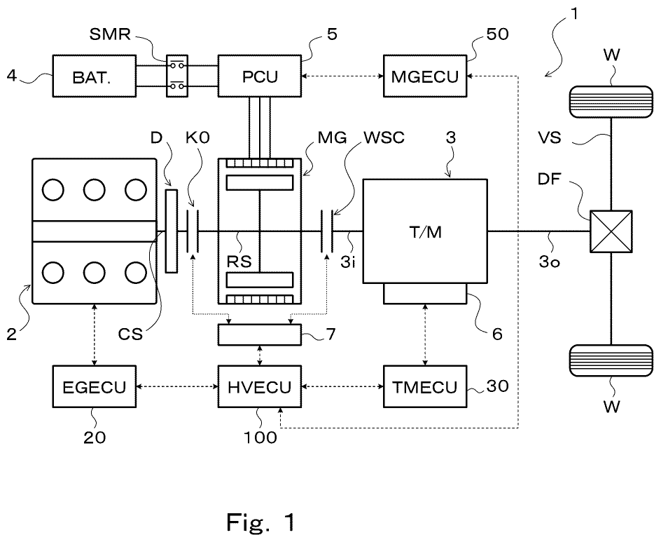

FIG. 1 is a schematic configuration diagram illustrating a hybrid vehicle 1 of the present disclosure. The hybrid vehicle 1 illustrated in the figure includes an engine (internal combustion engine) 2, a motor generator (electric motor) MG, a transmission 3, clutches K0 and WSC, a battery (energy storage device) 4, a power control unit (hereinafter refer to “PCU”) 5 that drives the motor generator MG, and hydraulic control devices 6 and 7. Further, the hybrid vehicle 1 includes an engine electronic control unit (hereinafter refer to “EGECU”) 20 that controls the engine 2, a transmission electronic control unit (hereinafter refer to “TMECU”) 30 that controls the transmission 3, a motor electronic control unit (hereinafter refer to “MGECU”) 50 that controls the PCU 5, and a hybrid electronic control unit (hereinafter refer to “HVECU”) 100. The HVECU 100 exchanges information with the EGECU 20, the TMECU 30, and the MGECU 50 to comprehensively control the hybrid vehicle 1.

Engine 2 is a multi-cylinder gasoline engine (for example, a V-type six-cylinder engine) that converts a reciprocating motion of pistons caused by combustion of a mixture of gasoline (hydrocarbon fuel) and air in multiple combustion chambers (cylinders) into a rotational motion of the crankshaft (output shaft) CS. The engine 2 includes an electronically controlled throttle valve, a plurality of intake valves, a plurality of exhaust valves, a variable valve mechanism, a plurality of fuel injection valves, a plurality of spark plugs, an exhaust purifier, and a supercharger such as a turbocharger (all of which are not shown in the figure). The crankshaft CS of the engine 2 is connected to an input member of a damper mechanism D (for example, a flywheel damper). The engine 2 may be a diesel engine, an LPG engine, or the like.

The motor generator MG is a synchronous generator motor (three-phase AC motor) that includes a rotor with embedded permanent magnets and a stator with wound three-phase coils, and exchanges electric power with the battery 4 via the PCU 5. The motor generator MG is driven by the electric power from the battery 4 to work as an electric motor to generate drive torque, and also outputs regenerative braking torque when the hybrid vehicle 1 is braked. The motor generator MG also works as a generator that generates electric power with at least a portion of the power from the engine 2, which is operated under load. As shown in FIG. 1, the rotor of the motor generator MG is fixed to the rotor shaft RS.

The transmission 3 is, for example, a 4-10 speed change type multistage transmission including an input shaft 3i as a drive shaft, an output shaft 3o, a plurality of planetary gears, a plurality of clutches and brakes (speed change engagement elements). The transmission 3 changes the power transmitted to the input shaft 3i into multiple speeds and outputs the power from the output shaft 3o to left and right wheels (rear wheels) W via a differential gear DF and axles VS. The clutch and brake of transmission 3 are hydraulic engagement elements driven by hydraulic pressure supplied from hydraulic controller 6.

Clutch K0 connects an output member of the damper mechanism D (the crankshaft CS of the engine 2) to the rotor shaft RS (the rotor of the motor generator MG) and also decouples them. When clutch K0 is engaged, the engine 2 (the crankshaft CS) is connected to the motor generator MG via the clutch K0. The clutch WSC connects the rotor shaft RS (the rotor of the motor generator MG) and the input shaft 3i of the transmission 3, and also decouples them. When the clutch WSC is engaged, the motor generator MG is connected to the transmission 3 via the clutch WSC. That is, the engine 2 is connected to the left and right wheels W via the damper mechanism D, the clutch K0, the rotor shaft RS (motor generator MG), the clutch WSC, the transmission 3, the differential gear DF, and so on. In this embodiment, the clutches K0 and WSC are, for example, normally-open multi-disc hydraulic clutches driven by hydraulic pressure supplied from the hydraulic control device 7, which is different from the hydraulic control device 6. The clutches K0 and WSC may be located inside the rotor of the motor generator MG.

The battery 4 is a lithium-ion rechargeable battery or a nickel-metal hydride rechargeable battery with a rated output voltage of about 200-800 V, for example. The battery 4 may be a capacitor or include both a rechargeable battery and a capacitor. The PCU 5 includes an inverter that drives the motor generator MG, a boost converter, a DC/DC converter, and the like (none of which are shown), and is connected to the battery 4 via a system main relay SMR. The inverter, for example, includes six transistors as switching elements and six diodes connected in parallel in opposite directions to these transistors. The boost converter boosts voltage from the battery 4 and supplies it to the inverter, and also steps down voltage from the inverter and supplies it to the battery 4. The DC/DC converter steps down electric power from the battery 4 or the inverter and supplies it to an auxiliary battery and various auxiliary equipment, and the like (none of which are shown in the figure).

The hydraulic control devices 6 and 7 respectively include a valve body with a plurality of oil paths, a plurality of regulator valves, and a plurality of linear solenoid valves. The hydraulic control device 6 regulates hydraulic oil (oil pressure) from an electric oil pump (not shown) and supplies it to the clutch and brake of the transmission 3. The hydraulic control device 7 regulates the hydraulic oil (oil pressure) from the electric oil pump and supplies it to the clutches K0 and WSC. The clutch and brake of transmission 3, the clutches K0 and the WSC may be driven by a single hydraulic control device.

The EGECU 20, which controls the engine 2, includes a microcomputer with CPU, ROM, RAM, input/output interface and the like, various drive circuits, and various logic ICs, which are not shown in the figure. The EGECU 20 acquires detection values from various sensors such as a crank angle sensor, an air flow meter, a throttle position sensor, an air-fuel ratio sensor, a water temperature sensor, and an accelerator pedal position sensor (all of which are not shown), and also receives command signals and the like from the HVECU 100. Further, the EGECU 20 calculates a rotation speed Ne of the engine 2 (crankshaft CS) based on the detected value of the crank angle sensor, and also calculates a load factor KL based on the rotation speed Ne of the engine 2 and an intake air volume detected by the air flow meter. The EGECU 20 also calculates (estimates) an estimated output torque Teest of the engine 2 based on the intake air volume, ignition timing, and the like in accordance with a well-known estimation method. The EGECU 20 then controls the throttle valve, the variable valve mechanism, the fuel injection valve, the spark plugs and the like based on the detected values of various sensors, calculated values such as the rotation speed Ne, and command signals from the HVECU 100.

The TMECU 30 includes a microcomputer with CPU, ROM, RAM, input/output interface and the like, various drive circuits, and various logic ICs, which are not shown in the figure. The TMECU 30 acquires detected values of various sensors, such as a shift position sensor, an accelerator pedal position sensor, an input rotation speed sensor that detects rotation speed of the input shaft 3i, an output rotation speed sensor that detects rotation speed of the output shaft 3o, and a vehicle speed sensor (all of which are not shown), and also receives command signals and the like from the HVECU 10. The TMECU 30 controls the transmission 3, that is, the hydraulic control device 6, based on detected values of various sensors and the command signal from the HVECU 100.

The MGECU 50 includes a microcomputer with CPU, ROM, RAM, input/output interface and the like, various drive circuits, various logic ICs and the like, which are not shown in the figure. The MGECU 50 acquires voltages before and after the boost converter, the rotational position of the rotor (rotor shaft RS) of the motor generator MG detected by a rotational position sensor (resolver), phase current applied to the motor generator MG and the like, and also receives command signals and the like from the HVECU 100. The MGECU 50 controls switching of the inverter and the boost converter based on these detected values and the command signals and the like from the HVECU 100.

The HVECU 100 includes a microcomputer with CPU, ROM, RAM, input/output interface and the like, various drive circuits, various logic ICs, and the like, which are not shown in the figure. The HVECU 100 acquires signals from a start switch (IG switch), an accelerator opening degree Acc (amount of depressing the accelerator pedal) detected by the accelerator pedal position sensor, vehicle speed V detected by the vehicle speed sensor, a gear position γ of the transmission 3 corresponding to the accelerator opening degree Acc and the vehicle speed V, a rotation speed Nm of the motor generator MG from the MGECU 50 and the like. Further, the HVECU 100 acquires from an electric power management device (electric power management ECU), not shown in the figure, SOC of the battery 4 calculated by the electric power management device, a target charge/discharge power Pb* based on the SOC, an allowable charge electric power Win, an allowable discharge electric power Wout and the like. The HVECU 100, on the basis of these information, sets a torque command Te* for the engine 2, a torque command Tm* for the motor generator MG, a command value to the transmission 3 (hydraulic control device 6) and the like, and also controls the clutches K0 and WSC, that is, the hydraulic control device 7.

Driving modes of the hybrid vehicle 1 configured as described above include an EV driving mode and an HEV driving mode. The EV driving mode drives the hybrid vehicle 1 while the clutch K0 is released and the clutch WSC is fully engaged or slip-engaged. The HEV driving mode drives the hybrid vehicle 1 with both clutches K0 and WSC fully engaged or slip-engaged and the engine 2 in operation.

During driving of the hybrid vehicle 1, the HVECU 100 sets a required torque Tout that is required to be output to the output shaft 3o of the transmission 3 by the driver to drive the hybrid vehicle 1, based on the accelerator opening degree Acc and the vehicle speed V. Further, the HVECU 100 sets a required torque Tireq that is required to be output to the input shaft 3i of the transmission 3 by the driver by dividing the required torque Tout by a gear ratio (ratio of rotation speeds of the input shaft 3i and the output shaft 30) in the gear position γ of the transmission 3. Then, the HVECU 100 applies a gradual change process such as annealing or a rate process to the required torque Tireq as necessary, and sets the required torque Tireq or a value obtained by the gradual change process to the torque command Ti* that indicates a torque to be output to the input shaft 3i.

After setting the torque command Ti*, the HVECU 100 sets the torque command Te* for the engine 2 (Te*=0 in the EV driving mode) and the torque command Tm* for the motor generator MG such that the battery 4 is charged or discharged at the target charge/discharge power Pb* separately set based on the SOC and the like and a torque corresponding to the torque command Ti* is output to the input shaft 3i of the transmission 3. Further, the HVECU 100 sends the torque command Te* for the engine 2 to the EGECU 20 and the torque command Tm* for the motor generator MG to the MGECU 50. The EGECU 20 executes an intake air volume control, a fuel injection control, an ignition timing control and the like for the engine 2 based on the received torque command Te*. The MGECU 50 executes switching control of the inverter and the like of the PCU 5 based on the received torque command Tm*.

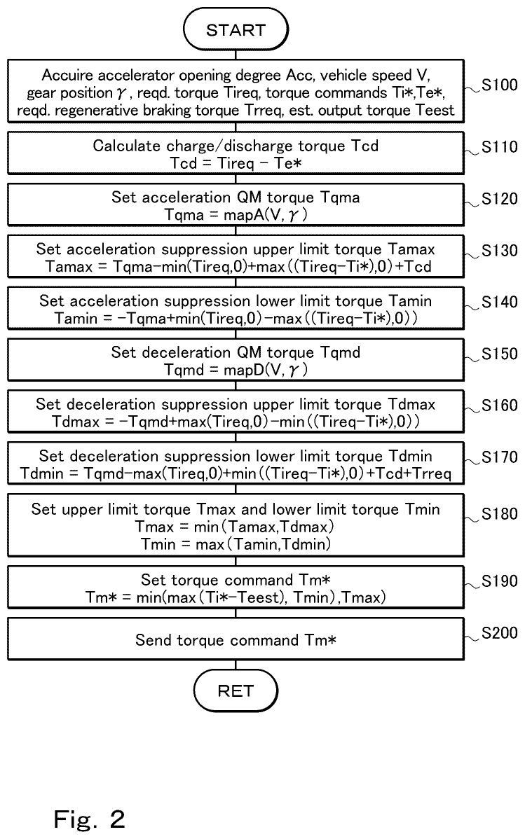

Next, with reference to FIGS. 2 to 5, the control procedure of the motor generator MG while the above hybrid vehicle 1 drives in the HEV driving mode is explained.

FIG. 2 is a flowchart illustrating an example of a routine that is repeatedly executed by the HVECU 100 every predetermined time (minute time) when the hybrid vehicle 1 drives in the HEV driving mode. When an execution timing of the routine in FIG. 2 arrives, the HVECU 100 acquires information necessary for controlling the motor generator MG (step S100). The information acquired in the step S100 includes the accelerator opening degree Acc, the vehicle speed V, the gear position γ of the transmission 3, the required torque Tireq in accordance with to the driver's request, the torque commands Ti* and Te*, a required regenerative braking torque Trreq, and the estimated output torque Teest of the engine 2.

The required regenerative braking torque Trreq is set separately in accordance with depression of a brake pedal by the driver of the hybrid vehicle 1. The required regenerative braking torque Trreq is obtained by multiplying a shared amount of the motor generator MG with respect to a braking force required by the driver by a predetermined conversion factor. When the brake pedal is not depressed by the driver, the required regenerative braking torque Trreq is zero. The estimated output torque Teest is calculated separately by the EGECU 20 as described above. The estimated output torque Teest includes an engine brake torque (friction torque) output from the engine 2 in addition to an estimated drive torque output from the engine 2.

After processing the step S100, the HVECU 100 calculates a charge/discharge torque Tcd by subtracting the torque command Te* from the required torque Tireq (step S110). The charge/discharge torque Tcd is a torque output to the input shaft 3i as the battery 4 is charged or discharged. In other words, when a sign of the charge/discharge torque Tcd is positive, the charge/discharge torque Tcd is a drive torque output to the input shaft 3i as a result of the discharge of the battery 4. When the sign of the charge/discharge torque Tcd is negative, the charge/discharge torque Tcd is a regenerative torque that is output to the input shaft 3i as the battery 4 is charged.

Further, the HVECU 100 sets an acceleration quality management torque (hereinafter referred to as “acceleration QM torque”) Tqma based on the vehicle speed V obtained in the step S100 and the gear position γ of the transmission 3 (step S120). The acceleration QM torque Tqma is a maximum torque (positive value) enabling an acceleration state of the hybrid vehicle 1 to be within a range of quality management in Automotive Safety Integrity Level (ASIL) when the acceleration QM torque Tqma is further output to the input shaft 3i of the transmission 3 in addition to a torque corresponding to the torque command Ti* under predefined preconditions. In the step S120, the HVECU 100 acquires the acceleration QM torque Tqma corresponding to the vehicle speed V and the gear position γ acquired in the step S100 from the acceleration QM torque setting map (not shown) created in advance. The acceleration QM torque setting map has been adapted in advance through experiments and analysis based on the various characteristics of the hybrid vehicle 1 to define a correlation between the vehicle speed V, the gear position γ of the transmission 3 (a gear ratio in the gear position γ), and the acceleration QM torque Tqma.

Then, the HVECU 100 calculates an acceleration suppression upper limit torque Tamax of the motor generator MG based on the acceleration QM torque Tqma set in the step S120 in accordance with following formula (1) (step S130). Further, the HVECU 100 calculates an acceleration suppression lower limit torque Tamin of the motor generator MG based on the acceleration QM torque Tqma in accordance with the following formula (2) (step S140). The acceleration suppression upper limit torque Tamax and the acceleration suppression lower limit torque Tamin are used to suppress rapid acceleration of the hybrid vehicle 1 by making a difference between the torque command Ti* that indicates the torque to be output to the input shaft 3i as the drive shaft and an actual torque output to the input shaft 3i within an allowable range based on quality management.

$$Ta max = Tqma - min ( Tireq , 0 ) + max ( ( Tireq - {Ti}^{★} ) , 0 ) + Tcd \qquad ( 1 )$$

$$Ta min = - Tqma + min ( Tireq , 0 ) - max ( ( Tireq - {Ti}^{★} ) , 0 ) \qquad ( 2 )$$

The acceleration suppression upper limit torque Tamax is obtained by correcting the acceleration QM torque Tqma by the smaller of the required torque Tireq and zero, the greater of the difference between the required torque Tireq and the torque command Ti* and zero, and the charge/discharge torque Tcd. The acceleration suppression lower limit torque Tamin is obtained by correcting a reciprocal number of the acceleration QM torque Tqma by the smaller of the required torque Tireq and zero, and the larger of the difference between the required torque Tireq and the torque command Ti* and zero. As seen from the equations (1) and (2), the acceleration suppression lower torque limit Tamin is the reciprocal number of a value obtained by subtracting the charging/discharging torque Tcd from the acceleration suppression upper torque limit Tamax.

Here, when the required torque Tireq is the negative value, the acceleration of the hybrid vehicle 1 decreases in accordance with the output of the required torque Tireq to the input shaft 3i. Therefore, there is no need to limit the output of the required torque Tireq that decreases the acceleration in order to suppress the rapid acceleration of the hybrid vehicle 1. Thus, when the required torque Tireq is the negative value, an absolute value of the required torque Tireq is added to the acceleration suppression upper limit torque Tamax, as seen from the equation (1). Further, as seen from the equation (2), the absolute value of the required torque Tireq is subtracted from the acceleration suppression lower limit torque Tamin.

The gradual change process, such as annealing, is intended to suppress the occurrence of shocks and the like. A limit amount of torque command Ti* by the gradual change process is set such that there is no risk of rapid acceleration or deceleration of the hybrid vehicle 1 even if a torque corresponding to the limit amount is additionally output from the motor generator MG. Therefore, when the torque command Ti* is limited to be smaller (negative) than the required torque Tireq by the gradual change process, in order to allow the output of torque equivalent to the limited amount of torque command Ti* by the gradual change process, as shown in the equation (1), the limited amount of torque command Ti* by the said gradual change process (=Tireq−Ti* (absolute value)) is added to the acceleration control upper limit torque Tamax. As shown in the equation (2), the limit amount is subtracted from the acceleration suppression lower limit torque Tamin. The target charge/discharge power Pb* of battery 4 is not affected by estimation accuracy of the estimated output torque Teest of engine 2. Therefore, the charging/discharging torque Tcd calculated in the step S120 is added to the acceleration suppression upper limit torque Tamax so as to allow the discharge of battery 4 and the charging of battery 4 by the power generated by the motor generator MG.

Further, the HVECU 100 sets a deceleration quality management torque (hereinafter referred to as “deceleration QM torque”) based on the vehicle speed V obtained in the step S100 and the gear position γ of the transmission 3 (step S150). The deceleration QM torque Tqmd is a minimum torque (negative value) that enables a deceleration state of the hybrid vehicle 1 to be within a range of quality management in Automotive Safety Integrity Level when the deceleration QM torque Tqmd is further output to the input shaft 3i of the transmission 3 in addition to the torque corresponding to the torque command Ti* under predefined preconditions. In the step S150, the HVECU 100 acquires the deceleration QM torque Tqmd corresponding to the vehicle speed V and the gear position γ acquired in the step S100 from the deceleration QM torque setting map (not shown) created in advance. The deceleration QM torque setting map is adapted in advance through experiments and analysis based on the various characteristics of the hybrid vehicle 1 to define a correlation between the vehicle speed V, the gear position γ of the transmission 3 (the gear ratio in the gear position γ), and the deceleration QM torque Tqmd.

Next, the HVECU 100 calculates a deceleration suppression upper limit torque Tdmax of the motor generator MG based on the deceleration QM torque Tqmd set in the step S150 in accordance with following equation (3) (step S160). Further, the HVECU 100 calculates the deceleration suppression lower limit torque Tdmin of the motor generator MG based on the deceleration QM torque Tqmd in accordance with following equation (4) (step S170). The upper deceleration suppression limit torque Tdmax and the lower deceleration suppression limit torque Tdmin are used to suppress rapid deceleration of the hybrid vehicle 1 by making the difference between the torque command Ti* that indicates the torque to be output to the input shaft 3i as the drive shaft and the actual torque output to the input shaft 3i within the allowable range based on quality management

$$Td max = - Tqmd + max ( Tireq , 0 ) - min ( ( Tireq - {Ti}^{★} ) , 0 ) \qquad ( 3 )$$

$$Td min = Tqmd - max ( Tireq , 0 ) + min ( ( Tireq - {Ti}^{★} ) , 0 ) + Tcd + Trreq \qquad ( 4 )$$

The deceleration suppression upper limit torque Tdmax is obtained by correcting the reciprocal number of the deceleration QM torque Tqmd by the greater of the required torque Tireq and zero and the smaller of the difference between the required torque Tireq and the torque command Ti* and zero. The deceleration suppression lower limit torque Tdmin is obtained by correcting the reciprocal number of the deceleration QM torque Tqmd by the greater of the required torque Tireq and zero, the smaller of the difference between the required torque Tireq and the torque command Ti* and zero, the charge/discharge torque Tcd, and the required regenerative braking torque Trreq. As seen from the equations (3) and (4), the deceleration suppression upper limit torque Tdmax is the reciprocal number of a value obtained by subtracting the charge/discharge torque Tcd and the required regenerative braking torque Trreq from the deceleration suppression lower limit Tdmax.

Here, when the required torque Tireq is a positive value, the deceleration of the hybrid vehicle 1 decreases in accordance with the output of the required torque Tireq to the input shaft 3i. Therefore, there is no need to limit the output of the required torque Tireq that decreases the deceleration in order to suppress the rapid deceleration of the hybrid vehicle 1. Thus, when the required torque Tireq is a positive value, the required torque Tireq (absolute value) is added to the deceleration suppression upper limit torque Tdmax, as shown in the equation (3). Further, as shown in the equation (4), the required torque Tireq (absolute value) is subtracted from the deceleration suppression lower limit torque Tdmin.

Further, when the torque command Ti* is limited to the positive side (larger) than the required torque Tireq by the gradual change process in order to allow the output of torque equivalent to the limit amount of the torque command Ti* by the gradual change process, as shown in the equation (3), the limit amount of the torque command Ti* (=Tireq−Ti* (absolute value)) by the gradual change process is added to the deceleration suppression upper limit torque Tdmax. As shown in the equation (4), the limit amount is subtracted from the deceleration suppression lower limit torque Tdmin. Further, the charge/discharge torque Tcd calculated in the step S120 is added to the deceleration suppression lower limit torque Tdmin so as to allow the discharge of the battery 4 and the charging of the battery 4 by the power generated by the motor-generator MG. The required regenerative braking torque Trreq is not affected by the estimation accuracy of the estimated output torque Teest of the engine 2. Therefore, the required regenerative braking torque Trreq acquired in the step S100 is added to the deceleration suppression lower limit torque Tdmin such that the regenerative braking torque output by the motor generator MG is allowed.

After processes S130-S170, the HVECU 100 sets the smaller of the acceleration suppression upper limit torque Tamax and the deceleration suppression upper limit torque Tdmax to the upper limit torque Tmax, and sets the larger of the acceleration suppression lower limit torque Tamin and the deceleration suppression lower limit torque Tdmin to the lower limit torque Tmin (step S180). Further, the HVECU 100 sets one of the upper limit torque Tmax and the larger of the value obtained by subtracting the estimated output torque Teest of the engine 2 obtained in step S100 from the torque command Ti* and the lower limit torque Tmin to the torque command Tm* for the motor generator MG (step S190). Then, the HVECU 100 sends the torque command Tm* to the MGECU 50 (step S200) and terminates the routine in FIG. 2 once and for all. The MGECU 50 executes switching control of the inverter of PCU 5 and the like based on the received torque command Tm*.

As has been described above, the hybrid vehicle 1 includes the engine 2 connectable to the input shaft 3i of the transmission 3 as the drive shaft via the clutches K0 and WSC, the motor generator MG connectable to the input shaft 3i of the transmission 3 via the clutch WSC, the battery 4 that exchanges electric power with the motor generator MG, and the HVECU 100 and MGECU 50 as control units. The HVECU 100 and the MGECU 50 are included as control devices. The HVECU 100 sets the upper limit torque Tmax and the lower limit torque Tmin of the motor generator MG such that the difference between the torque command Ti* indicating the torque to be output to the input shaft 3i and the actual torque output to input shaft 3i is within the allowable range based on quality management, based on the operating conditions of the hybrid vehicle 1 (vehicle speed V, gear position γ, and the like) (steps S100-S180 in FIG. 2). Further, the HVECU 100 controls the motor generator MG in cooperation with the MGECU 50 so as to output the torque according to the difference between the torque command Ti* and the estimated output torque Teest of the engine 2 within the range from the lower limit torque Tmin to the upper limit torque Tmax (Steps S190 and S200).

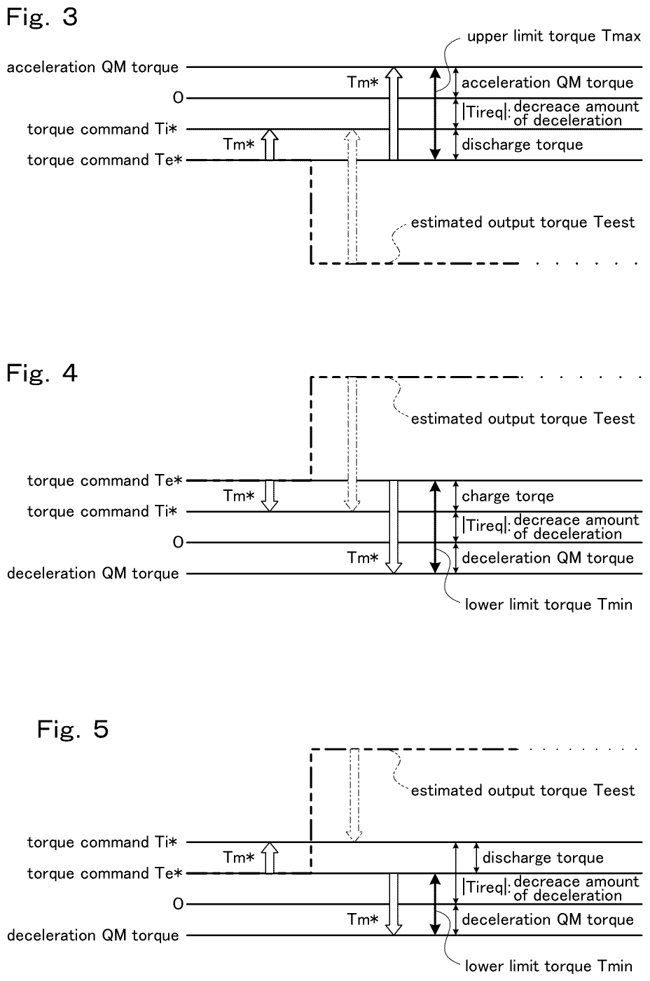

As shown in FIGS. 3, 4, and 5, when the estimated output torque Teest of the engine 2 deviates from the actual output torque of the engine 2 (see the double-dotted line in the figure), the torque command Tm* of the motor generator MG is limited by the upper limit torque Tmax or the lower limit torque Tmin. This prevents the actual output torque of the motor generator MG from deviating from the actual required motor torque, thereby allowing the hybrid vehicle 1 to accelerate or decelerate properly.

The HVECU 100 sets the acceleration QM torque Tqma and deceleration QM torque Tqmd based on the vehicle speed V and the gear position γ of the transmission 3 such that the acceleration state and the deceleration state of the hybrid vehicle 1 are within the range of quality management in the Automobile Safety Integrity Level, and also sets the upper limit torque Tmax and lower limit torque Tmin based on the acceleration QM torque Tqma and the deceleration QM torque Tqmd (steps S100-S180). This eliminates the need to apply a development process compliant with functional safety standards for control using the estimated output torque Teest of the engine 2. As a result, the hybrid vehicle 1 allows the monitoring process of the estimation accuracy of the estimated output torque Teest of the engine 2, which requires time and effort for proper adaptation of the abnormality judgment threshold, to be omitted, thereby reducing the manufacturing cost. That is, the technique of the present disclosure is useful for a hybrid vehicle 1 with the engine 2 including the turbocharger, in which the estimated output torque Teest tends to deviate from the actual output torque of the engine 2.

the upper limit torque Tmax and lower limit torque Tmin with the required torque Tireq that is required to be output to the input shaft 3i of the transmission 3 by the driver so as to allow the acceleration and the deceleration of the hybrid vehicle 1 to decrease, as shown in FIGS. 3 to 5 (steps S120-S180). This enables the hybrid vehicle 1 to drive in response to the driver's requirement by adjusting the limit of the output torque of the motor generator MG in accordance with the sign of the required torque Tireq, while making the acceleration state and the deceleration state of the hybrid vehicle 1 within the range of quality management in the Automobile Safety Integrity Level.

The HVECU 100 corrects the upper limit torque Tmax and lower limit torque Tmin by the limit amount of torque command Ti* (=Tireq−Ti*) by the gradual change process such that the acceleration and the deceleration of the hybrid vehicle 1 are allowed to increase when the torque command Ti* is subjected to the gradual change process (Steps S120-S180). This suppresses the output torque of the motor generator MG from being limited more than necessary and enables the hybrid vehicle 1 to drive in accordance with the driver's requirements.

Further, the HVECU 100 corrects the upper limit torque Tmax and lower limit torque Tmin so as to allow the discharge of the battery 4 and the charging of the battery 4 by the power generated by the motor generator MG (steps S120-S180). This allows the SOC of the battery 4 to be properly maintained while making the acceleration state and the deceleration state of the hybrid vehicle 1 within the range of quality management in the Automobile Safety Integrity Level.

In the hybrid vehicle 1, when an upshift or a downshift of the transmission 3 is requested, the output torque of the motor generator MG is reduced or increased to cancel out a moment of inertia associated with the upshift or the downshift. This increases or decreases in the output torque of the motor generator MG due to a shift in transmission 3 is unaffected by the estimation accuracy of the estimated output torque Teest of the engine 2. Therefore, the upper limit torque Tmax and lower limit torque Tmin described above may be corrected by an increase or a decrease in the output torque of the motor generator MG associated with the shift of the transmission 3.

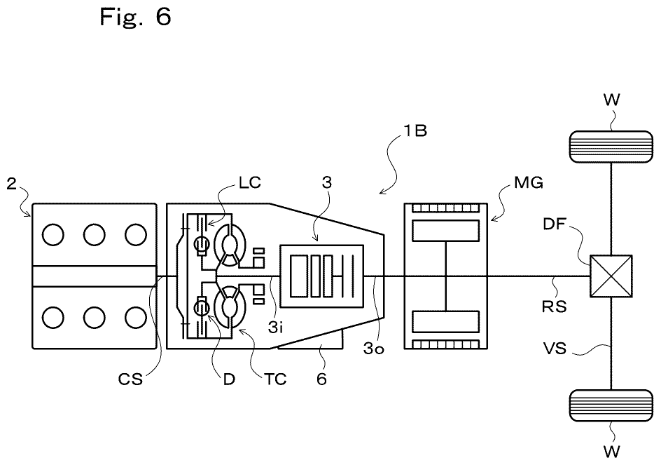

The hybrid vehicle 1 may also be a four-wheel drive vehicle that includes a transfer or another motor generator to drive wheels not shown (front wheels) other than wheels W. Further, in the hybrid vehicle 1B shown in FIG. 6, the motor generator MG may be controlled in the same manner as in the hybrid vehicle 1 described above.

In the hybrid vehicle 1B shown in FIG. 6, the input shaft 3i of the transmission 3 is connected to the crankshaft CS of the engine 2 via a lock-up clutch LC, a damper mechanism D and a torque converter TC. The output shaft 3o of the transmission 3 is connected (directly connected) to the rotor shaft RS fixed to the rotor of the motor generator MG, and is connected to the wheels W via the motor generator MG (rotor shaft RS) and the differential gear DF. The hybrid vehicle 1B, by setting the upper limit torque Tmax and the lower limit torque Tmin as described above, enables to suppress the deviation of the actual output torque of the motor generator MG from the actually required motor torque. Further, the hybrid vehicle 1B may also be a four-wheel drive vehicle that includes the transfer or another motor-generator to drive the wheels (front wheels) not shown in the figure other than the wheels W.

The disclosure is not limited to the above embodiments in any sense but may be changed, altered or modified in various ways within the scope of extension of the disclosure. Additionally, the embodiments described above are only concrete examples of some aspect of the disclosure described in Summary and are not intended to limit the elements of the disclosure described in Summary.

### INDUSTRIAL APPLICABILITY

The technique of the present disclosure is applicable to, for example, the manufacturing industry of the hybrid vehicle.

1. A hybrid vehicle that includes an engine connectable to a drive shaft, an electric motor connectable to the drive shaft, and a battery that exchanges electric power with the electric motor, the hybrid vehicle comprising:
a controller that sets an upper limit torque and a lower limit torque of the electric motor such that a difference between a torque command indicating a torque to be output to the drive shaft and an actual torque output to the drive shaft is within an allowable range based on an operational condition of the hybrid vehicle, and controls the electric motor to output a torque based on a difference between the torque command and an estimated output torque of the engine within a range from the lower limit torque to the upper limit torque.

2. The hybrid vehicle according to claim 1, further comprising:
a transmission that is connected to the drive shaft and transmits a power from the drive shaft to wheels,
wherein the controller sets the upper limit torque and the lower limit torque based on a vehicle speed and the gear position of the transmission such that an acceleration state and a deceleration state of the hybrid vehicle are within a range of quality management in an automotive safety integrity level.

3. The hybrid vehicle according to claim 2,
wherein the controller corrects the upper limit torque and the lower limit torque with a required torque that is required to be output to the drive shaft by a driver so as to allow a reduction in the acceleration and deceleration of the hybrid vehicle.

4. The hybrid vehicle according to claim 3,
wherein the controller corrects the upper limit torque and the lower limit torque with a limitation amount of the torque command in a gradual change process so as to allow an increase in the acceleration and the deceleration of the hybrid vehicle when the gradual change process is applied to the torque command.

5. The hybrid vehicle according to claim 3,
wherein the electric motor is configured to generate electric power with at least a portion of a power from the engine, and
wherein the controller corrects the upper limit torque and the lower limit torque so as to allow a discharge of the battery and a charge of the battery by electric power generated by the electric motor.

6. The hybrid vehicle according to claim 4,
wherein the electric motor is configured to generate electric power with at least a portion of a power from the engine, and
wherein the controller corrects the upper limit torque and the lower limit torque so as to allow a discharge of the battery and a charge of the battery by electric power generated by the electric motor.
